(19) United States
(12) Patent Application Publication
(10) Pub. No.: US 2018/0096584 A1
(43) Pub. Date: Apr. 5, 2018

(54) CAR-KEY SEARCHING SYSTEM

(71) Applicant: SEUNG KYU CHOI, Dangjin-si (KR)

(72) Inventor: SEUNG KYU CHOI, Dangjin-si (KR)

(21) Appl. No.: 15/597,255

(22) Filed: May 17, 2017

(30) Foreign Application Priority Data
Oct. 1, 2016 (KR) 20-2016-0005700

(51) Int. Cl. G08B 21/24; G08B 7/00; H04B 1/3827

(52) U.S. Cl. CPC G08B 21/24; H04B 1/3833; G08B 7/00

(57) ABSTRACT

There is provided a car-key searching system comprising: a car-key searching device configured to generate a car-key device alarm request message in a response to a car-key device alarm request from a user, and to transmit the message to a searched car-key device; and the searched car key device configured to generate a vibration or a sound upon receiving the car-key device alarm request message from the car-key searching device.

### CROSS-REFERENCE TO RELATED APPLICATION

This application claims the benefit of Korean utility model application No. 20-2016-0005700 filed on Oct. 1, 2016, the entire content of which is incorporated herein by reference for all purposes as if fully set forth herein.

### BACKGROUND

### Field of the Present Disclosure

The present disclosure relates to a car-key searching system.

### Discussion of Related Art

In recent years, with the generalization of automobile electronic keys, a driver can use a key such as a FOB key to open and close a door from the outside without separate key insertion or activation button pressing. Furthermore, it is possible to detect whether or not the vehicle key is indoors. In the case of being indoors, the user starts the vehicle by simply pressing a start button without inserting a FOB key into a key hole. This may be referred to as a button starter technique. This technique will become a main trend in future developed vehicles.

Generally, a pair of car-key devices may be provided to the user for a single vehicle. The two car-key devices may be separately used to perform functions such as start-on/off, door lock/release, and the like.

However, normally, the car-key device is often missed somewhere. Occasionally, a user may not be able to find the key device when children place the car-key device somewhere in the house.

Therefore, there is an urgent need for car-key device searching means that allows the user to easily find the car-key device and prevent the loss of the car-key device.

### PRIOR ART DOCUMENT

### Patent Literature

(Patent Document 1) Korean Patent Publication No. 10-2011-0063207

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide a car-key device searching system that allows the user to easily find the car-key device and prevent the loss of the car-key device.

In one aspect of the present disclosure, there is provided a car-key searching system comprising: a car-key searching device configured to generate a car-key device alarm request message in a response to a car-key device alarm request from a user, and to transmit the message to a searched car-key device; and the searched car key device configured to generate a vibration or a sound upon receiving the car-key device alarm request message from the car-key searching device.

In one implementation, the car-key searching device is embodied as a smartphone, wherein the smartphone includes: a RF communication module configured to wirelessly communicate with the searched car-key device; a car-key device registration module on which two or more car-key device unique IDs are registered, wherein the searched car-key device is registered on the registration module; a touch-screen panel having an alarm type selection menu configured to select one of a vibration or sound as an car-key device alarm type; a car-key searching application configured to broadcast the car-key device alarm request message via the RF communication module in a response to the car-key device alarm request from the user, wherein the message includes a unique ID of a car-key device registered in the car-key device registration module and an alarm type selected via the alarm type selection menu.

In one implementation, the touch-screen panel includes a to-be-searched car-key device selection menu configured to allow the user to select the searched car-key device for generating the car-key device alarm.

In one implementation, unique IDs of two or more car-key devices are registered on the car-key device registration module.

In one implementation, the car-key searching application is configured to broadcast the car-key device alarm request message via the RF communication module wherein the message includes a unique ID of the searched car-key device selected via the to-be-searched car-key device selection menu.

In one implementation, the car-key searching device is embodied as a searching car-key device.

In one implementation, both of the searched car-key device and the searching car-key device are configured to control the same car.

In one implementation, the searching car-key device are configured to broadcast the car-key device alarm request message including a unique ID of the searched car-key device in a response to the car-key device alarm request from the user.

In one implementation, the searching car-key device includes a car-key device searching button for receiving the car-key device alarm request from the user.

In one implementation, the searching car-key device is configured: to broadcast a first car-key device alarm request message in a response to the car-key device searching button being pressed down for a shorter time than a predetermined time, wherein the first car-key device alarm request message requests the searched car-key device to generate sound; and to broadcast a second car-key device alarm request message in a response to the car-key device searching button being pressed down for a longer time than the predetermined time, wherein the second car-key device alarm request message requests the searched car-key device to generate vibration.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a configuration diagram of a car-key searching system according to an embodiment of the present disclosure.

FIG. 2 is a block diagram of a smart phone as a car-key searching device according to an embodiment of the present disclosure.

FIG. 3 is a diagram illustrating a smart phone showing an execution icon of a car-key searching application according to an embodiment of the present disclosure.

FIG. 4 is a diagram illustrating a smart phone in which an alarm type selection menu and a to-be-searched car-key device selection menu are displayed according to an embodiment of the present disclosure.

FIG. 5 is a diagram illustrating a smart phone as a car-key searching device broadcasting a car-key device alarm request message to a searched car-key device according to an embodiment of the present disclosure.

FIG. 6 is a diagram illustrating a car-key device implemented as the car-key searching device according to an embodiment of the present disclosure.

FIG. 7 is a diagram illustrating a car-key searching device broadcasting a car-key device alarm request message to a searched car-key device according to an embodiment of the present disclosure.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As described below, embodiments explained in accordance with the present disclosure may be implemented and performed on a processor, a microprocessor, a controller or a chip.

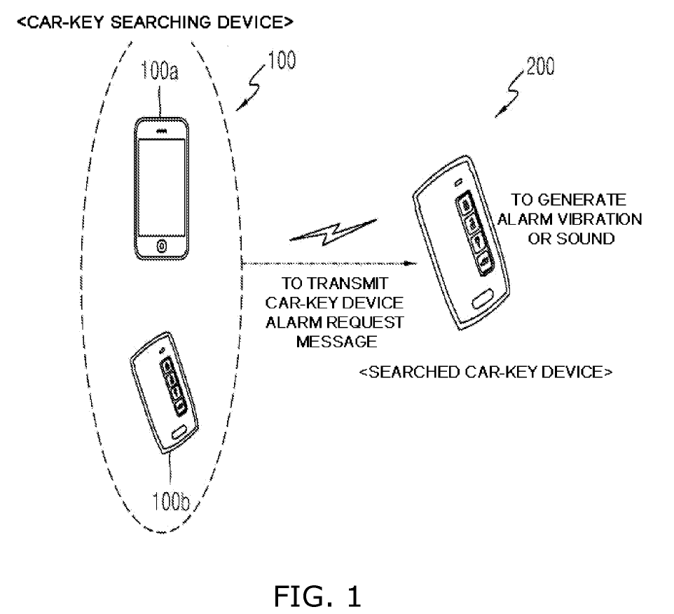

FIG. 1 is a configuration diagram of a car-key searching system according to an embodiment of the present disclosure.

According to the present disclosure, a user can easily find the position of a car key device by causing the car key device to generate a vibration or an alarm sound when the car key device is left somewhere or when the young child places the car key device somewhere in the house.

To this end, the car-key searching system according to the present disclosure includes a car-key searching device 100 and a searched car-key device 200.

When there occurs a car-key device alarm request from the user, the car-key searching device 100 generates a car-key device alarm request message and transmits the car-key device alarm request message to a pre-registered car-key device (hereinafter referred to as the searched car-key device 200. That is, when the user does not know where the searched car-key device 200 is located, the user instructs a car-key searching device 100 to generate the car-key device alarm request message and transmit the car-key device alarm request message to the pre-registered car-key device 200 such that the searched car-key device 200 generates a vibration or an alarm sound. That is, the car-key searching device 100 requests the searched car-key device 200 to generate the vibration or the alarm sound. In a response to the receipt of the request message, the searched car-key device 200 generates the vibration or the alarm sound.

When the searched car-key device 200 receives the car-key device alarm request message from the car-key searching device 100, the searched car-key device 200 generates the vibration or alarm sound. To this end, the searched car-key device 200 may be provided with a speaker for generating sound and a vibration motor for vibrating the key device. Thus, the user can easily find the searched car-key device 200 currently generating the vibration or alarm sound. The searched car-key device 200 may be implemented as a smart key, such as a FOB key provided by an automobile manufacturer, and may be a car-key device capable of wireless transmission and wireless reception.

Meanwhile, according to the present disclosure, the car-key searching device 100 may be implemented as a smart phone 100a or a searching car-key device 100b, which is another car-key device.

When the car-key searching device 100 is implemented as the smartphone 100a, the user authenticates himself/herself using an authentication application in the smart phone. The smartphone then signals a message to the user's car-key device to sound or vibrate. In this way, the user may identify the location of the car-key device. The user may usually receive two car key devices from the car manufacturer. In this connection, one of the two car-key devices may act as the car-key searching device 100 while the other may act as the searched car-key device 200. In one example, the sound and vibration may also be individually selected. Such an application may be supplied by automobile manufacturers.

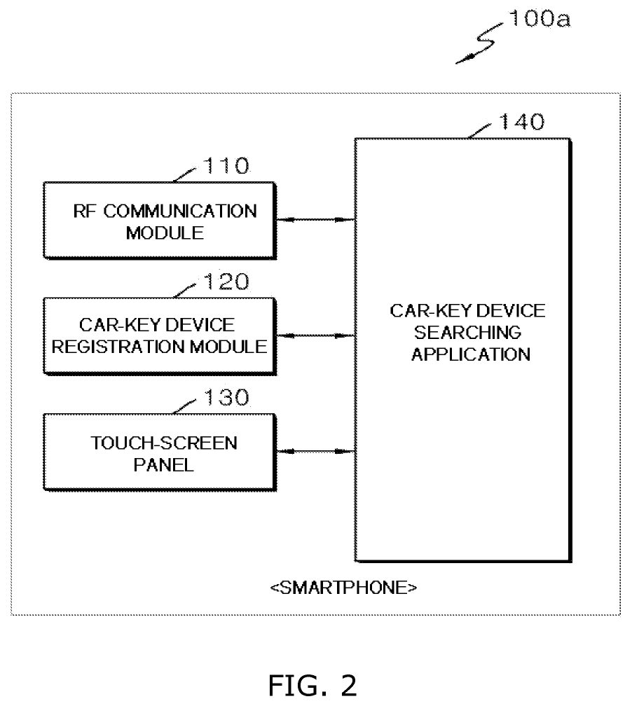

An example in which the car-key searching device 100 is implemented as the smartphone 100a will be described with reference to FIGS. 2 to 5, which will be described later.

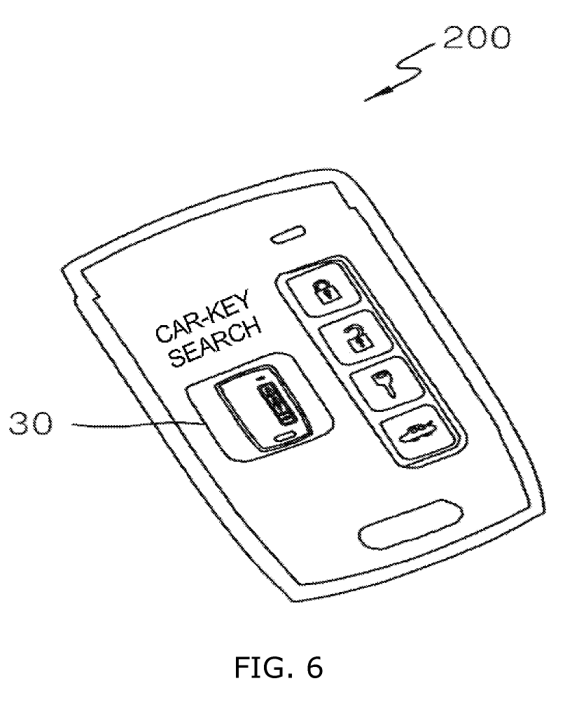

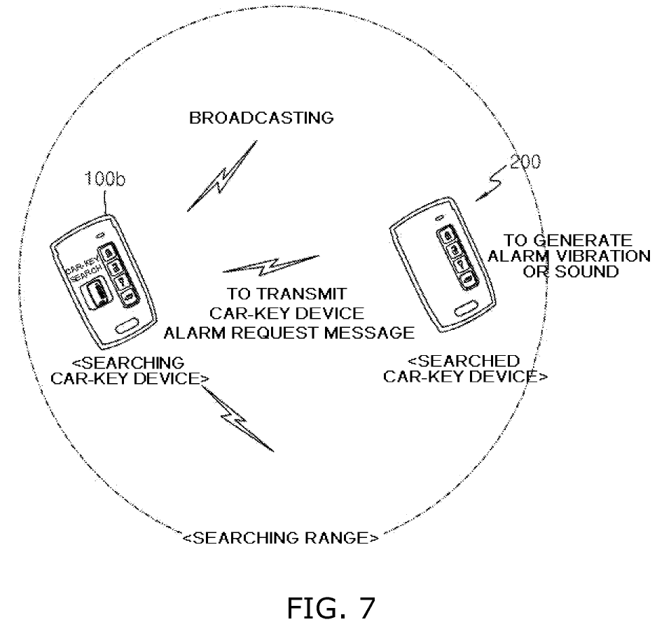

In addition, when the car-key searching device 100 is implemented as another car-key device, said another car-key device used as the car-key searching device 100 may be one car-key searching device among two car-key devices supplied from the car manufacturer. Generally, there are two car-key devices for one car. Accordingly, when one car-key device is lost, another car-key device may be used as the car-key searching device 100. In the following description, the car key device that generates the alarm request message in order to find a lost car-key device may be referred to as a searching car-key device 100b. An example in which the searching car-key device 100b is implemented as the car-key searching device 100 will be described with reference to FIGS. 6 and 7 to be described later.

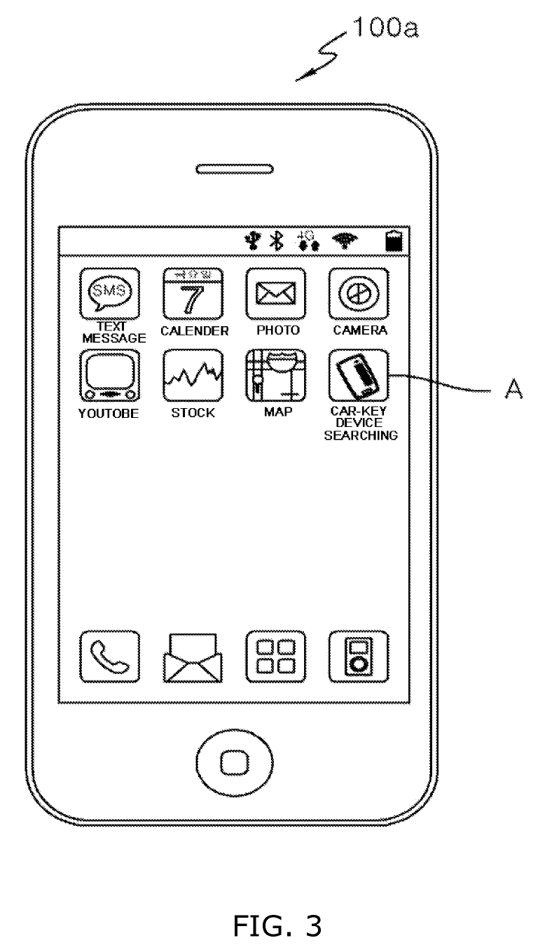

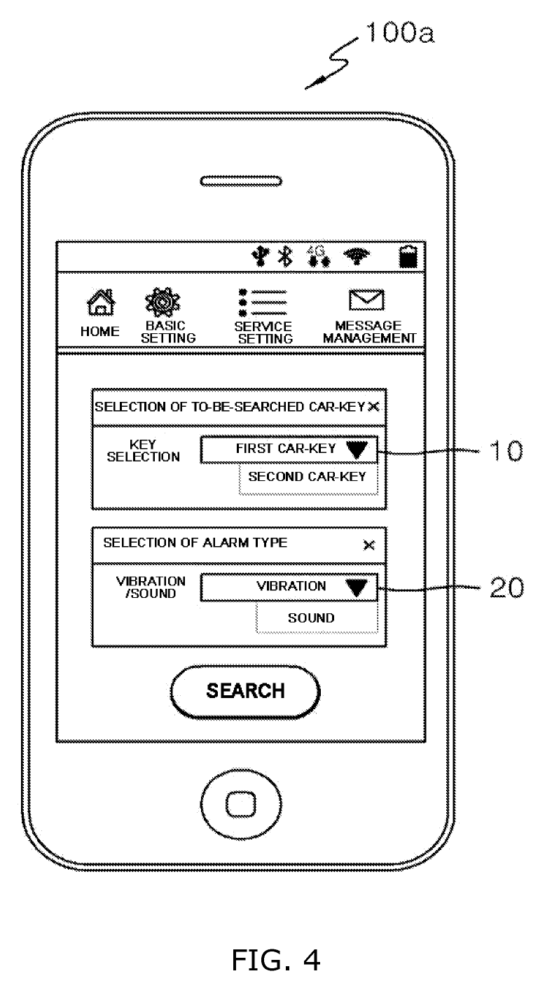

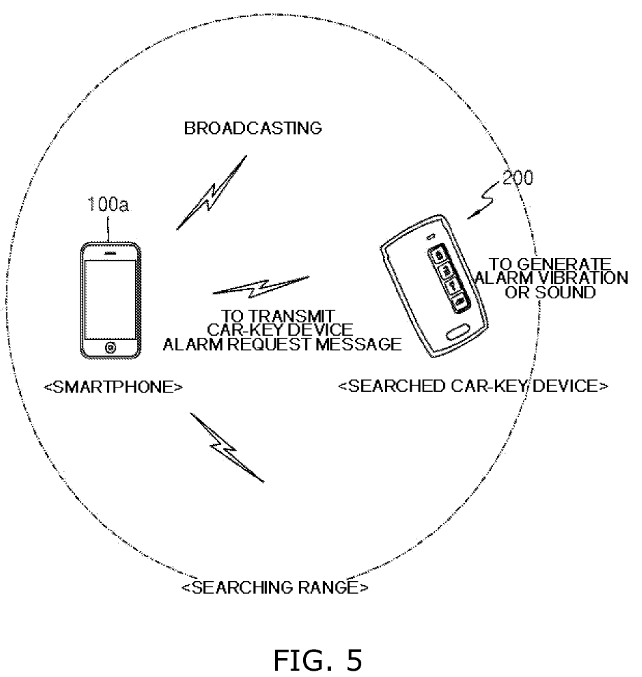

FIG. 2 is a block diagram of a smart phone as a car-key searching device according to an embodiment of the present disclosure. FIG. 3 is a diagram illustrating a smart phone showing an execution icon of a car-key searching application according to an embodiment of the present disclosure. FIG. 4 is a diagram illustrating a smart phone in which an alarm type selection menu and a to-be-searched car-key device selection menu are displayed according to an embodiment of the present disclosure. FIG. 5 is a diagram illustrating a smart phone as a car-key searching device broadcasting a car-key device alarm request message to a searched car-key device according to an embodiment of the present disclosure.

The car-key searching device 100 may be implemented as the smartphone 100a, which is an intelligent terminal that has computer-aided functions such as Internet communication and information retrieval. The smartphone may have an application desired by the user. Unlike conventional mobile phones, hundreds of various applications can be installed and added to or deleted from the smartphone as desired by the user. In addition, the user can directly produce an application desired by the user. This makes it possible to implement an appropriate interface for the user using various applications. The present disclosure is not limited to the smartphone 100a, but may be equally be applied to a tablet PC, a slate PC, and other mobile computing devices.

The smartphone bow as shown in FIG. 2 includes an RF communication module 110, a car-key device registration module 120, a touch-screen panel 130, and a car-key device searching application 140.

The RF communication module 110 may be provided with an antenna for wireless communication with the searched car-key device 200. Such an antenna may be implemented as an antenna of GHz band for mobile communication. Alternatively, the antenna may be implemented as a separate antenna capable of processing several tens MHz and several hundred MHz bands. Preferably, such an antenna may be implemented as an antenna capable of processing a radio communication band for a car-key device provided by an automobile manufacturer.

The car-key device registration module 120 may allow a user to register unique identities of two or more car-key devices thereto. The carmaker provides the user with two car-key devices per one car. The unique IDs of these two car-key devices are registered and stored in the car-key device registration module 120. The car-key device registration module 120 may be embodied as a module capable of inputting and outputting information, and may be provided inside the smartphone or as a separate device. In one embodiment, the car-key device registration module 120 may be embodied as a hard disk drive, a solid state drive (SSD), a flash memory, a compact flash card, an SD card (secure digital card), an SM card (smart media card), an MMC card (multi-media Card), or a memory stick, etc.

The touch-screen panel 130 displays an alarm type selection menu 20. Using this menu, the user selects one of the alarm types, for example, the vibration or sound, to be generated by the car-key device to be searched. The touch-screen panel 130 may be a panel via which input and output operations may be performed, and may provide a touch screen capable of simultaneously performing input and output operations. This panel may be provided as a front face portion of the terminal or smartphone and may serve as a display window for displaying a work screen. The panel uses a graphical user interface (GUI).

As shown in FIG. 3, when the execution icon A of the car-key device searching application 140 is touched or activated, the car-key device searching application 140 performs user login authentication. As shown in FIG. 4, the car-key device searching application 140 selects an alarm type from the user via the alarm type selection menu 20. When there occurs a car-key device alarm request from the user, the car-key device searching application 140 broadcasts the car-key device alarm request message to the searched car-key device via the RF communication module 110. In this regard, the car-key device alarm request message includes a unique ID of the car-key device registered in the car-key device registration module 120 and the alarm type selected via the alarm type selection menu 20. As shown in FIG. 5, when the searched car-key device receives the car-key device alarm request message through the broadcasting, the searched car-key device determines whether the received unique ID matches a unique ID thereof. When the received unique ID matches the unique ID thereof, the searched car-key device determines that it is very a target car-key device to be detected. Thus, the searched car-key device generates a requested vibration or alarm sound so that the user can find the searched car-key device.

Furthermore, according to the present disclosure, the present system may further include a selection means for selecting a car-key device to be searched among a plurality of car-key devices from a user. To this end, the touch-screen panel 130 includes a to-be-searched car-key device selection menu 10, as shown in FIG. 4. Using the to-be-searched car-key device selection menu 10, the user selects the searched car-key device 200 that should generate the car-key device alarm. Therefore, when there are two or more car-key devices for the same car, the user can select a single target car-key device to be searched.

In the car-key device registration module 120, unique IDs of two or more car-key devices must be registered. Thus, the car-key searching application broadcasts the car-key device alarm request message to the searched car-key device 200 via the RF communication module 110. The message includes the unique ID of the searched car-key device 200 selected via the to-be-searched car-key device selection menu 10. Thus, the selected car-key device 200 may be requested to generate an alarm.

FIG. 6 is a diagram illustrating a car-key device implemented as the car-key searching device according to an embodiment of the present disclosure. FIG. 7 is a diagram illustrating a car-key searching device broadcasting a car-key device alarm request message to a searched car-key device according to an embodiment of the present disclosure.

When the car-key searching device boo is implemented as a searching car-key device boob, which is another car-key device, searching efficiency may very good.

For example, when the user does not know where his/her car is parked in a large parking lot, a button on the car-key device may be pushed to ring the car's horn. However, with this principle, it is not possible to know where a primary key is located. When the user is unable to use the mobile phone, or when the user is unfamiliar with using the smartphone 100a, or when the smartphone application is not available due to the security issue, the user can use an auxiliary car-key device to check the location of the lost primary car-key device.

For this purpose, the searched car-key device 200 and the searching car-key device boob may be implemented as a pair of car-key devices capable of controlling the same car. As shown in FIG. 7, when the car-key device alarm request is generated from the user, the searching car-key device boob transmits the car key device 200 having the unique ID of the searched car-key device alarm request message to the searched car-key device 200.

The searching car-key device boob includes a car-key device searching button 30 for receiving the car-key device alarm request from the user, as shown in FIG. 6.

When the car-key device searching button 30 is pressed for a shorter time than a predetermined time by the user (for example, a short touch within 1 second), the searching car-key device boob broadcasts a first car-key device alarm request message to the searched car-key device 200 where the first message requests the sound generation. Alternatively, when the car-key device searching button 30 is pressed for a longer time than the predetermined time by the user (for example, a long press within 2 to 3 seconds), the searching car-key device 100b broadcasts a second car-key device alarm request message to the searched car-key device 200 where the second message requests the vibration generation.

Therefore, the car-key device searching button 30 is formed on each of the two car-key devices. Accordingly, when the user presses the car-key device searching button 30 of any one of the two car-key devices for a short time, the sound is generated from the other car-key device. Alternatively, when the user presses and holds the car-key device searching button 30 of one of the two car-key devices for a long time, vibration occurs from the other car-key device. This will help the user find the lost car key.

The addition of the further button to the car-key device may cause the key device to be complex in a configuration and be aesthetically poor. In this case, generally-used and existing buttons on the key device may be used for the key searching purpose. For example, when the user presses a horn button for a short time, this button functions as a horn button to allow the user to find his car in a large parking lot. When the user presses and holds down the same horn button for 2-3 seconds, this button acts as a key searching button to enable the lost key device to sound and/or vibrate. This may be equally applied to a car door locking button on the key device. Specifically, when the user presses the car door locking button for a short time, this button functions as a car door locking button to allow the user to lock a door of his car. When the user presses and holds down the same door locking button for 2-3 seconds, this button acts as a key searching button to enable the lost key device to sound and/or vibrate.

Moreover, any processes or modules or functions described with respect to FIGS. 1-7, as well as any other aspects of the disclosure, may each be implemented by software, but may also be implemented in hardware, firmware, or any combination of software, hardware, and firmware. They each may also be embodied as machine- or computer-readable code recorded on a machine- or computer-readable medium. The computer-readable medium may be any data storage device that can store data or instructions which can thereafter be read by a computer system. Examples of the computer-readable medium may include, but are not limited to, read-only memory, random-access memory, flash memory, CD-ROMs, DVDs, magnetic tape, and optical data storage devices. The computer-readable medium can also be distributed over network-coupled computer systems so that the computer readable code is stored and executed in a distributed fashion. For example, the computer-readable medium may be communicated from one electronic subsystem or device to another electronic subsystem or device using any suitable communications protocol. The computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module or state machine discussed herein may be provided as a software construct, firmware construct, one or more hardware components, or a combination thereof. For example, any one or more of the state machines or modules may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules or state machines are merely illustrative, and that the number, configuration, functionality, and interconnection of existing modules may be modified or omitted, additional modules may be added, and the interconnection of certain modules may be altered.

Whereas many alterations and modifications of the present disclosure will no doubt become apparent to a person of ordinary skill in the art after having read the foregoing description, it is to be understood that the particular embodiments shown and described by way of illustration are in no way intended to be considered limiting. Therefore, reference to the details of the preferred embodiments is not intended to limit their scope.

What is claimed is:

1. A car-key searching system comprising:
a car-key searching device configured to generate a car-key device alarm request message in a response to a car-key device alarm request from a user, and to transmit the message to a searched car-key device; and
the searched car key device configured to generate a vibration or a sound upon receiving the car-key device alarm request message from the car-key searching device,
wherein the car-key searching device is embodied as a smartphone,
wherein the smartphone includes:
a RF communication module configured to wirelessly communicate with the searched car-key device;
a car-key device registration module on which two or more car-key device unique IDs are registered, wherein the searched car-key device is registered on the registration module;
a touch-screen panel having an alarm type selection menu configured to select one of a vibration or sound as an car-key device alarm type;
a car-key searching application configured to broadcast the car-key device alarm request message via the RF communication module in a response to the car-key device alarm request from the user, wherein the message includes a unique ID of a car-key device registered in the car-key device registration module and an alarm type selected via the alarm type selection menu,
wherein the touch-screen panel includes a to-be-searched car-key device selection menu configured to allow the user to select the searched car-key device for generating the car-key device alarm,
wherein unique IDs of two or more car-key devices are registered on the car-key device registration module,
wherein the car-key searching application is configured to broadcast the car-key device alarm request message via the RF communication module wherein the message includes an unique ID of the searched car-key device selected via the to-be-searched car-key device selection menu.

2. A car-key searching system comprising:
a car-key searching device configured to generate a car-key device alarm request message in a response to a car-key device alarm request from a user, and to transmit the message to a searched car-key device; and
the searched car key device configured to generate a vibration or a sound upon receiving the car-key device alarm request message from the car-key searching device,
wherein the car-key searching device is embodied as a searching car-key device,
wherein both of the searched car-key device and the searching car-key device are configured to control the same car,
wherein the searching car-key device are configured to broadcast the car-key device alarm request message including a unique ID of the searched car-key device in a response to the car-key device alarm request from the user,
wherein the searching car-key device includes a car-key device searching button for receiving the car-key device alarm request from the user,
wherein the searching car-key device is configured:
to broadcast a first car-key device alarm request message in a response to the car-key device searching button being pressed down for a shorter time than a predetermined time, wherein the first car-key device alarm request message requests the searched car-key device to generate sound, and
to broadcast a second car-key device alarm request message in a response to the car-key device searching button being pressed down for a longer time than the predetermined time, wherein the second car-key device alarm request message requests the searched car-key device to generate vibration.
